(19) United States
(12) Patent Application Publication
(10) Pub. No.: US 2007/0150921 A1
(43) Pub. Date: Jun. 28, 2007

(54) DIVERSION OF MOBILE TELEVISION BROADCAST SIGNALS TO ALTERNATE DESTINATIONS BASED ON DEGRADING SIGNAL QUALITY

(75) Inventors: Ralf Mueller, Bellevue, WA (US); William O. Camp, Chapel Hill, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: Sony Ericsson Mobile Communications AB, Lund (SE)

(21) Appl. No.: 11/306,339

(22) Filed: Dec. 23, 2005

(51) Int. Cl. H04N 7/16

(52) U.S. Cl. 725/62

(57) ABSTRACT

A portable mobile communications device for diverting the destination of a mobile broadcast program broadcast by a mobile broadcast service provider includes a mobile broadcast device, a processor running a mobile broadcast diversion application communicable with the mobile broadcast service provider, and a user interface for controlling the mobile broadcast device and the mobile broadcast diversion application such that mobile broadcast programs can be diverted to an alternate device when the received signal quality of the mobile broadcast falls to unsatisfactory levels. The alternate device can include a home media server, a computer, or a mobile radio access network (M-RAN) coupled to and communicable with the mobile broadcast service provider via the Internet.

### BACKGROUND OF THE INVENTION

The present invention relates to portable mobile communications devices and systems, and more particularly to a portable mobile communications device, system and method that can divert mobile broadcast signals to an alternate device using a portable mobile communications device.

Portable mobile communications devices such as mobile phones are becoming more sophisticated and include many new features and capabilities. One such feature is the capability to receive mobile broadcast signals or mobile television or the like, such as digital video broadcast-handheld (DVB-H), digital media broadcast (DMB), integrated services digital broadcast-terrestrial (ISDB-T), mobile broadcast multi-cast service (MBMS), or similar technologies. When integrated into a mobile phone, all of the aforementioned technologies utilize a separate mobile television tuner except for MBMS which can be received using the portable mobile communications device existing mobile radio receiver and transmitter.

The convenience factor for receiving mobile broadcasting is high for mobile users. Unfortunately, the mobile user's viewing experience can sometimes be compromised if the received broadcast signal quality degrades. Signal degradation can be the result of many factors including interference, traveling beyond the range of the broadcast, equipment malfunction, etc. Unfortunately, signal quality degradation can occur in the middle of a broadcast that the viewer is enjoying. In such cases the viewer can lose the ability to view the broadcast altogether causing frustration and perhaps fees if the viewer paid a fee for the broadcast program.

Currently, there are no provisions addressing the user's dilemma described above. What is needed is a mechanism that allows the user to divert a mobile video broadcast from the source to an alternate device when the current signal quality degrades to an unacceptable level.

### BRIEF SUMMARY OF THE INVENTION

In accordance with an embodiment of the present invention, there is described a portable mobile communications device for diverting the destination of mobile broadcast programs broadcast by a mobile broadcast service provider. The portable mobile communications device includes a mobile broadcast device, a processor running a mobile broadcast diversion application communicable with the mobile broadcast service provider, and a user interface for controlling the mobile broadcast diversion application such that a mobile broadcast content can be diverted to an alternate device should the received signal quality of the mobile broadcast degrade on the portable mobile communications device. Alternate devices can include a home media server, a computer, or other video playback device coupled to and communicable with the mobile broadcast service provider via the Internet or other IP network. Or an alternate bearer can be selected to receive the mobile broadcast on the portable mobile communications device.

### BRIEF DESCRIPTION OF THE DRAWINGS

FIG. 1 is a block diagram of an exemplary system for diverting the destination of a mobile broadcast in accordance with an embodiment of the present invention.

FIG. 2 is a block diagram of an exemplary portable mobile communications device for use within the system of FIG. 1 for diverting the destination of a mobile broadcast in accordance with an embodiment of the present invention.

FIG. 3 is a flow chart of a method for diverting a mobile broadcast in accordance with an embodiment of the present invention.

### DETAILED DESCRIPTION OF THE INVENTION

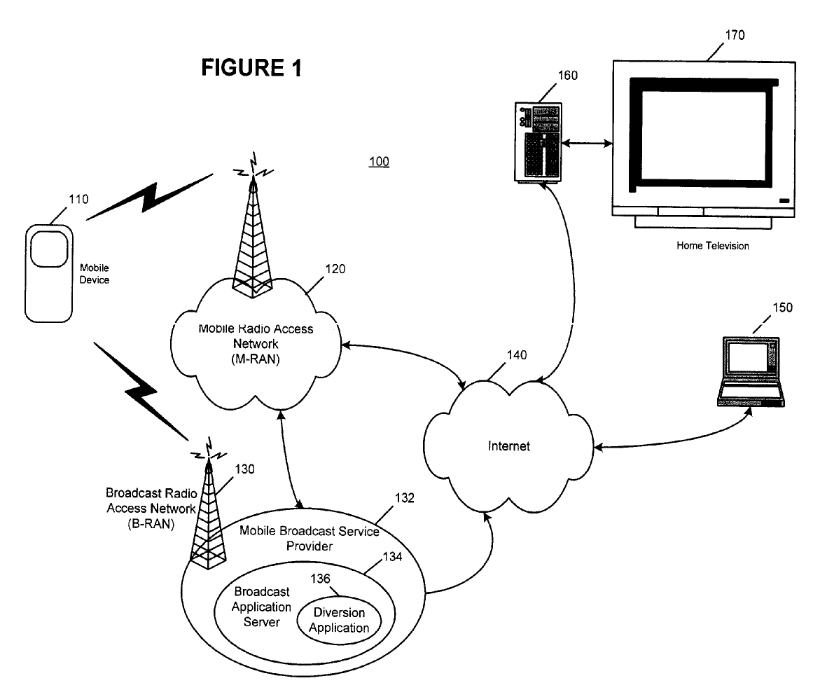

FIG. 1 is a block diagram of an exemplary system for diverting the destination of a mobile broadcast in accordance with an embodiment of the present invention. The system 100 may be a digital video broadcast-handheld (DVB-H), digital media broadcast (DMB), integrated services digital broadcast-terrestrial (ISDB-T), mobile broadcast multi-cast service (MBMS), or other similar technology. When integrated into a mobile phone, all of the aforementioned technologies utilize a separate mobile broadcast tuner except for MBMS which can be received using the portable mobile communications device existing mobile radio receiver and transmitter.

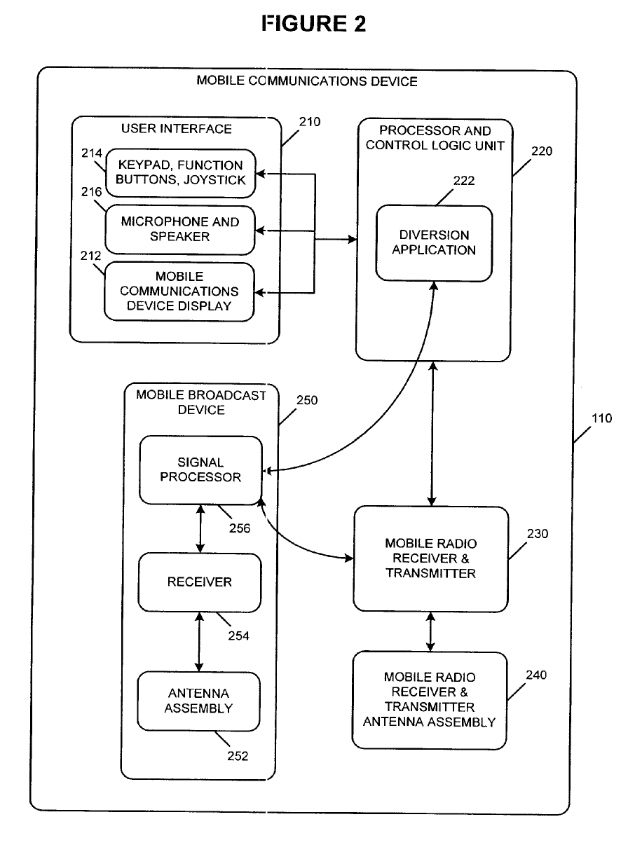

The portable mobile communications device 110 may be a cordless telephone, cellular telephone, personal digital assistant (PDA), communicator, computer device or the like and is not unique to any particular communications standard, such as Advanced Mobile Phone Service (AMPS), Digital Advanced Mobile Phone Service (D-AMPS), Global System for Mobile Communications (GSM), Code Division Multiple Access (CDMA) or the like. The design of the portable mobile communications device 110 illustrated in FIG. 2 is for purposes of explaining the present invention and the present invention is not limited to any particular design.

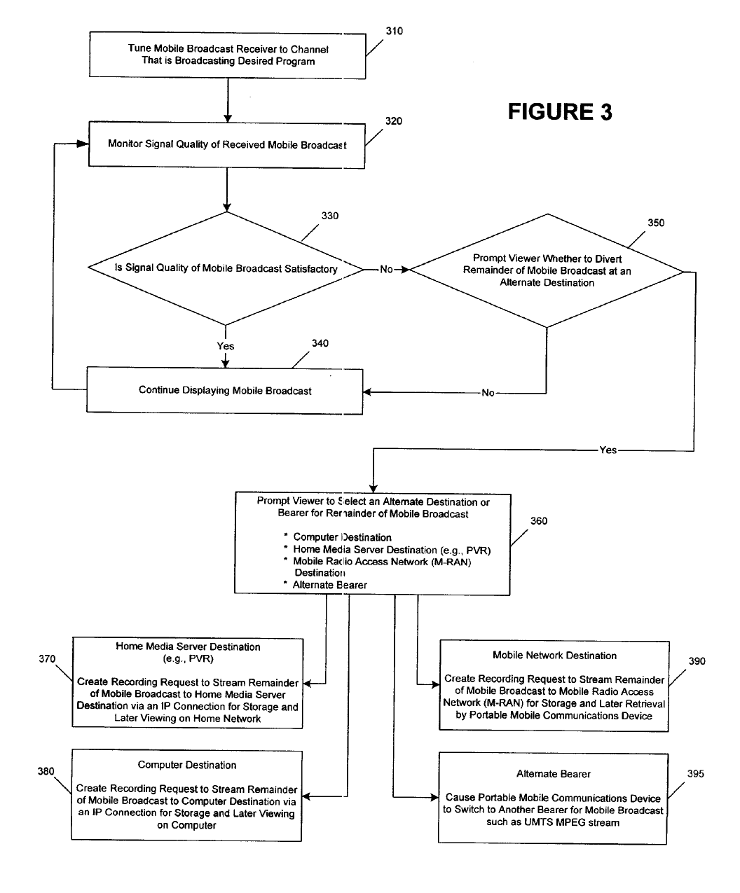

The portable mobile communications device 110 shown in FIG. 2 may include an operator or user interface 210 to facilitate controlling operation of the portable mobile communications device 110 including initiating and conducting phone calls and other communications. The user interface 210 may include a display 212 to provide visual signals to a subscriber or user as to the status and operation of the portable mobile communications device 110. The display 212 may be a liquid crystal display (LCD) or the like capable of presenting color images. The display 212 may provide information to a user or operator in the form of images, text, numerals, characters, a graphical user interface (GUI) and the like. The display 212 may also be used to present programming carried by the broadcast signals described with respect to method 300 of FIG. 3.

The user interface 212 may also include a keypad and function keys or buttons 214 including a pointing device, such as a joystick or the like. The keypad, function buttons and joystick 214 permit the user to communicate commands to the portable mobile communications device 110 to dial phone numbers, initiate and terminate calls, establish other communications, such as access to a mobile television provider, the Internet, send and receive email, text messages and the like. The keypad, function buttons and joystick 214 may also be used to control other operations of the portable mobile communications device 110. The keypad, function buttons and joystick 214 may also be implemented on a touch sensitive display adapted to receive tactile input.

The display 212, keypad, and function buttons 214 may be coupled to a main processor and control logic unit 220. The processor and control logic unit 220 may be a microprocessor or the like. The processor and logic unit 220 may include a feature 222 to enable redirecting broadcast signals to an alternate destination. The functions and operations described with respect to a portable mobile communications device 110 in the method of FIG. 3 may be embodied in an application 222 for diverting broadcast signals. The diversion application 222 may be embodied in hardware, firmware, software (data structures) or combinations thereof. The processor and logic unit 220 may also include other data structures, software programs, computer applications and the like to encode and decode control signals; perform communication procedures and other functions as described herein.

The user interface 210 may also include a microphone and a speaker 216. The microphone 216 may receive audio or acoustic signals from a user or from another acoustic source. The microphone 216 may convert the audio or acoustic signals to electrical signals. The microphone 21 6 may be connected to the processor and logic unit 220 wherein the processor and logic unit 220 may convert the electrical signals to baseband communication signals. The processor and control logic unit 220 may be connected to a mobile radio transmitter and receiver 230 that may convert baseband signals from the processor and control logic unit 220 to radio frequency (RF) signals. The mobile radio transmitter and receiver 230 may be connected to an antenna assembly 240 for transmission of the RF signals to a communication medium or system, such as a mobile radio access network (MRAN) 120 or the like. Mobile radio transmitter and receiver 230 can also receive mobile broadcasts according to the MBMS standard. In this scenario, the MRAN 120 acts as the mobile broadcast service provider.

The antenna assembly 240 may receive RF signals over the air and transfer the RF signals to mobile radio transmitter and receiver 230. The mobile radio transmitter and receiver 230 may convert the RF signals to baseband signals. The baseband signals may be applied to the processor and control logic unit 220 which may convert the baseband signals to electrical signals. The processor and control unit 220 may send the electrical signals to the speaker 216 which may convert the electrical signals to audio signals that can be understood by the user.

The portable mobile communications device 110 may also include a mobile broadcast device 250. The mobile broadcast device 250 may be a DVB-H type device or the like. The mobile broadcast device 250 may be integrally formed as part of the portable mobile communications device 110 or may be a separate unit that may be connected and operate in association with the portable mobile communications device 110. The mobile broadcast device 250 may include an antenna assembly 252 for receiving broadcast signals of programming from a mobile broadcast service provider, broadcast radio access network (B-RAN) 130 or the like. A receiver 254 may be coupled to the antenna assembly 252 to receive the broadcast signals. A signal processor 256 may receive the broadcast signals from the receiver 254 and convert the signals to a format for presentation on the display 212 of the portable mobile communications device 110. Or, a signal processor 256 may receive the broadcast signals from the receiver 230 and convert the signals to a format for presentation on the display 212 of the portable mobile communications device 110.

The B-RAN 130 may originate the mobile broadcast or DVB-H broadcast signals for broadcasting to communications devices or mobile broadcast devices, such as portable mobile communications device 110 and mobile broadcast device 250. The B-RAN 1 30 may include a transmitter to transmit the broadcast signals.

The B-RAN 130 may be connected to a mobile broadcast service provider 132. The mobile broadcast service provider 132 may originate programming for broadcasting to communications devices 110 or mobile broadcast devices 250 via the B-RAN 130. The mobile broadcast service provider 132 may include a broadcast application server 134. The broadcast application server 134 may include an application 136 for diverting broadcast signals.

The B-RAN 130 may be connected to the Internet 140 or other private network that may utilize Internet protocol (IP) or the like. The B-RAN 130 and the mobile broadcast service provider 132 may receive and transmit signals or messages to control the diversion of broadcast signals via the Internet 140.

In one embodiment of the present invention, as discussed with respect to method 300 of FIG. 3, a third party recorder such as a computer 150 or a third party record playback application server such as a home media server 160 may be options to receive the diverted broadcast signals and to record the programming carried by the redirected broadcast signals. The third party devices 150, 160 may be connected to the Internet 140 to receive the diverted broadcasted program. Then, at a later date, the user can access the third party devices 150, 160 and play back the recorded programming. In the case of a computer 150 (or other like device) the user can access the diverted broadcast directly via the computer and a suitable application hosted thereon. In the case of a home media server 160 (or other like device) the user can access the diverted broadcast via a television 170 (or television monitor) that is connected to the home media server 160. The combination of the home media server 160 and television 170 would include a suitable application for retrieving, manipulating, and viewing the redirected broadcasted program. The combination of a home media server 160 and television 170 may also be referred to as a personal video recorder or PVR.

Use of a third party device 150, 160 as a destination for diverted programming would typically be accomplished via an Internet 140 connection, preferably a broadband connection, between the mobile broadcast service provider 132 and the selected third party device(s) 150, 160. The user can control the destination of diverted programming from his portable mobile communications device 110 using its ability to wirelessly communicate with mobile broadcast service provider 132 through M-RAN 120. The diversion application 222 running on the portable mobile communications device 110 can send control signals to mobile broadcast service provider 132 indicating the destination preference(s) of selected programming. If the selected preference is a third party device 150, 160 then the mobile broadcast service provider 132 will, via its own diversion application 136, divert a stream of video via the Internet 140 to the desired alternate destination.

FIG. 3 is a flow chart of a method for diverting the destination of a mobile broadcast in accordance with an embodiment of the present invention. In block 310, the user/viewer tunes the mobile broadcast receiver within or attached to the portable mobile communications device to a channel that is broadcasting a desired program. In block 320, an application in the portable mobile communications device monitors the received signal quality of the received mobile broadcast. In block 330, the signal monitoring application determines whether the current received signal quality is satisfactory. Received signal quality can be measured in a variety of manners. One method would be to measure the signal to noise ratio of the broadcast signal and compare that measured value to a preset signal quality threshold. The decision to divert would occur, for instance, if the measured signal to noise ratio remained below that signal quality threshold for a preset period of time. Another method would be to measure the bit error rate (BER) of the broadcast signal. This can be done if the data is sent with an error correction and/or detection scheme. An example of an error detection only scheme would be a cyclic redundancy check (CRC) added to blocks of data that would detect that an error has occurred. An example of an error correction scheme would be a convolutional code with extra bits to both detect and correct errors. Either of these could then be used to calculate an error rate per time.

The program would monitor the level of errors occurring internally within the error correction process and trigger a diversion when the error level exceeds a preset signal quality threshold for a preset period of time. A signal quality threshold can be originally established as the dividing line between satisfactory and unsatisfactory signal quality. In addition, the threshold can be manually adjusted to suit viewer tolerances.

If the received signal quality is satisfactory the portable mobile communications device will continue to display the mobile broadcast as shown in block 340. The received signal will also continue to be monitored for subsequent changes to received signal quality.

If the received signal quality is unsatisfactory the viewer will be prompted, in block 350, whether to divert the remainder of the broadcast program to an alternate destination or to switch to an alternate bearer to receive the mobile broadcast. If the user/viewer opts not to divert the broadcast the portable mobile communications device will continue to display the mobile broadcast despite the quality of the received signal. Otherwise, in block 360, the user/viewer is prompted to select a diversion option. There are four listed diversion options. There may be other diversion options not listed herein that can readily be incorporated into the present invention. Thus, the four options described herein are not intended to be limiting.

A first diversion option, shown in block 370, is to divert the remainder of the mobile broadcast to a home server destination. When this option is selected the portable mobile communications device will create, via the diversion application, a request in the form of a message to be sent to the mobile broadcast service provider via the M-RAN. The message can be an SMS, MMS, HTTP (e-mail) message, or the like. The request message should contain, at a minimum, data identifying the mobile broadcast program to be diverted to the home media server destination and the IP address of the home media server destination. The mobile broadcast service provider, upon receipt and processing of the message, will begin a data streaming operation that will stream the requested mobile broadcast program content to the IP address included in the diversion request message. The home media server destination will begin receiving and storing the streamed data. The home media server destination can also send an acknowledgement message, via SMS or the like, back to the portable mobile communications device to inform the portable mobile communications device that the diversion request is being carried out. The user/viewer can then view the remainder of the mobile broadcast program at a later time using the home media server.

A second diversion option, shown in block 380, is to divert the remainder of the mobile broadcast to a computer destination. When this option is selected the portable mobile communications device will create, via the diversion application, a request in the form of a message to be sent to the mobile broadcast service provider via the M-RAN. The message can be an SMS, MMS, HTTP (e-mail) message, or the like. The request message should contain, at a minimum, data identifying the mobile broadcast program to be diverted to the computer destination and the IP address of the computer destination. The mobile broadcast service provider, upon receipt and processing of the message, will begin a data streaming operation that will stream the requested mobile broadcast program content to the IP address included in the diversion request message. The computer destination will begin receiving and storing the streamed data. The computer destination can also send an acknowledgement message, via SMS or the like, back to the portable mobile communications device to inform the portable mobile communications device that the diversion request is being carried out. The user/viewer can then view the remainder of the mobile broadcast program at a later time using the computer.

A third diversion option, shown in block 390, is to divert the remainder of the mobile broadcast to a mobile network (M-RAN) destination. When this option is selected the portable mobile communications device will create, via the diversion application, a request in the form of a message to be sent to the mobile broadcast service provider via the M-RAN. The message can be an SMS, MMS, HTTP (e-mail) message, or the like. The request message should contain, at a minimum, data identifying the mobile broadcast program to be diverted to the mobile network (M-RAN) destination and the IP address of the mobile network (M-RAN) destination. The mobile broadcast service provider, upon receipt and processing of the message, will begin a data streaming operation that will stream the requested mobile broadcast program content to the IP address included in the diversion request message. The mobile network (M-RAN) destination will begin receiving and storing the streamed data in a location accessible to the user/viewer. The mobile network (M-RAN) destination can also send an acknowledgement message, via SMS or the like, back to the portable mobile communications device to inform the portable mobile communications device that the diversion request is being carried out. The user/viewer can then view the remainder of the mobile broadcast program at a later time using the portable mobile communications device.

A fourth diversion option, shown in block 395, is to cause the portable mobile communications device to switch to an alternate bearer to receive the mobile broadcast. This option differs from the first three in that it does not cause the mobile broadcast to be sent to an alternate device. Rather, it asks the mobile broadcast service provider to switch to another broadcast means and continue sending the mobile broadcast. For instance, if the mobile broadcast is using DVB-H, the user/viewer may request that a different broadcast mechanism such as MPEG4 over UMTS or MBMS be used to continue broadcasting the program. In one example, the content would now flow to the M-RAN network via an IP gateway. An example of an IP gateway in a GPRS/E-GPRS cellular system is the GGSN (GSM Gateway Service Node.) It would then be sent on out over the M-RAN to the mobile unit.

Any prompts associated with the invention may be presented and responded to via an interactive voice feature, a graphical user interface (GUI) presented on the display of the portable mobile communications device, or the like.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A portable mobile communications device for diverting the destination of mobile broadcast programs broadcast by a mobile broadcast service provider when the received signal quality degrades to an unsatisfactory level in the portable mobile communications device comprising:
a mobile broadcast receiver;
a processor monitoring the received signal quality of the mobile broadcast and running a mobile broadcast diversion application communicable with the mobile broadcast service provider;
a user interface for controlling the mobile broadcast device and the mobile broadcast diversion application, such that mobile television broadcast programs can be diverted to an alternate device when the received signal quality degrades to an unsatisfactory level.

2. The portable mobile communications device of claim 1 wherein the received signal quality of the mobile broadcast is monitored using a peak signal to noise ratio (PSNR) reading.

3. The portable mobile communications device of claim 2 wherein an unsatisfactory signal quality level is determined when the current peak signal to noise ratio (PSNR) reading falls below a preset peak signal to noise ratio (PSNR) reading.

4. The portable mobile communications device of claim 1 wherein the received signal quality of the mobile broadcast is monitored using a bit error rate (BER) reading.

5. The portable mobile communications device of claim 4 wherein an unsatisfactory signal quality level is determined when the current bit error rate (BER) reading falls below a preset bit error rate (BER) reading.

6. On a portable mobile communications device, a method of diverting the destination of a mobile broadcast program broadcast by a mobile broadcast service provider to the portable mobile communications device, the method comprising:
monitoring the received signal quality of a mobile broadcast;
prompting, via a display on the portable mobile communications device, for an alternate destination for the selected broadcast program if the received signal quality of the mobile broadcast falls to an unsatisfactory level;
receiving input from a user interface on the portable mobile communications device, the input identifying the alternate destination for the selected broadcast program; and causing the diversion of the selected broadcast program from the mobile broadcast service provider to the alternate destination.

7. The method of claim 6 wherein causing the diversion of the selected broadcast program from the mobile broadcast service provider to the alternate destination comprises processing the received input for identifying the alternate destination for the selected broadcast program and wirelessly sending a message to the mobile broadcast service provider with instructions to stream the selected broadcast program content from the mobile broadcast service provider to the IP address of the alternate destination.

8. The method of claim 6 wherein the alternate destination includes a home media server coupled with the mobile broadcast service provider via the Internet.

9. The method of claim 6 wherein the alternate destination includes a computer coupled with the mobile broadcast service provider via the Internet.

10. The method of claim 6 wherein the alternate destination includes a mobile radio access network (M-RAN) coupled with the mobile broadcast service provider via the Internet.

11. On a portable mobile communications device, a computer program product embodied on a computer readable storage medium for diverting the destination of a mobile broadcast program broadcast by a mobile broadcast service provider to the portable mobile communications device, the computer program product comprising:
computer program code for monitoring the received signal quality of a mobile broadcast;
computer program code for prompting, via a display on the portable mobile communications device, for an alternate destination for the selected broadcast program if the received signal quality of the mobile broadcast falls to an unsatisfactory level;
computer program code for receiving input from a user interface on the portable mobile communications device, the input identifying the alternate destination for the selected broadcast program; and
computer program code for causing the diversion of the selected broadcast program from the mobile broadcast service provider to the alternate destination.

12. The computer program product of claim 11 wherein the computer program code for causing the diversion of the selected broadcast program from the mobile broadcast service provider to the alternate destination comprises processing the received input for identifying the alternate destination for the selected broadcast program and wirelessly sending a message to the mobile broadcast service provider with instructions to stream the selected broadcast program content from the mobile broadcast service provider to the IP address of the alternate destination.

13. On a portable mobile communications device, a method of switching the bearer for a mobile broadcast program broadcast by a mobile broadcast service provider to the portable mobile communications device, the method comprising:
monitoring the received signal quality of a mobile broadcast;
prompting, via a display on the portable mobile communications device, for an alternate bearer for the selected broadcast program if the received signal quality of the mobile broadcast falls to an unsatisfactory level on the original bearer;
receiving input from a user interface on the portable mobile communications device, the input identifying the alternate bearer for the selected broadcast program; and
switching the bearer of the selected broadcast program being broadcast from the mobile broadcast service provider to the portable mobile communications device.

14. The method of claim 13 wherein switching the bearer of the selected broadcast program being broadcast from the mobile broadcast service provider to the portable mobile communications device comprises processing the received input identifying the alternate bearer for the selected broadcast program and wirelessly sending a message to the mobile broadcast service provider with instructions to switch to the alternate bearer.

15. On a portable mobile communications device, a computer program product embodied on a computer readable storage medium for switching the bearer for a mobile broadcast program broadcast by a mobile broadcast service provider to the portable mobile communications device, the computer program product comprising:
computer program code for monitoring the received signal quality of a mobile broadcast;
computer program code for prompting, via a display on the portable mobile communications device, for an alternate bearer for the selected broadcast program if the received signal quality of the mobile broadcast falls to an unsatisfactory level on the original bearer;
computer program code for receiving input from a user interface on the portable mobile communications device, the input identifying the alternate bearer for the selected broadcast program; and
computer program code for switching the bearer of the selected broadcast program being broadcast from the mobile broadcast service provider to the portable mobile communications device.

16. The computer program product of claim 15 wherein the computer program code for switching the bearer of the selected broadcast program being broadcast from the mobile broadcast service provider to the portable mobile communications device comprises computer program code for processing the received input identifying the alternate bearer for the selected broadcast program and wirelessly sending a message to the mobile broadcast service provider with instructions to switch to the alternate bearer.

17. A portable mobile communications device for automatically diverting the destination of mobile broadcast programs broadcast by a mobile broadcast service provider when the received signal quality degrades to an unsatisfactory level in the portable mobile communications device comprising:
a mobile broadcast receiver;
a processor monitoring the received signal quality of the mobile broadcast and running a mobile broadcast diversion application communicable with the mobile broadcast service provider;
such that mobile television broadcast programs can be automatically diverted to an alternate device when the received signal quality degrades to an unsatisfactory level.

18. The portable mobile communications device of claim 17 wherein the received signal quality of the mobile broadcast is monitored using a peak signal to noise ratio (PSNR) reading.

19. The portable mobile communications device of claim 18 wherein an unsatisfactory signal quality level is determined when the current peak signal to noise ratio (PSNR) reading falls below a preset peak signal to noise ratio (PSNR) reading.

20. The portable mobile communications device of claim 17 wherein the received signal quality of the mobile broadcast is monitored using a bit error rate (BER) reading.

21. The portable mobile communications device of claim 20 wherein an unsatisfactory signal quality level is determined when the current bit error rate (BER) reading falls below a preset bit error rate (BER) reading.

22. On a portable mobile communications device, a method of automatically switching the bearer for a mobile broadcast program broadcast by a mobile broadcast service provider to the portable mobile communications device, the method comprising:
monitoring the received signal quality of a mobile broadcast;
determining when the received signal quality of the mobile broadcast falls to an unsatisfactory level on the original bearer;
automatically identifying an alternate bearer capable for the selected broadcast program; and
automatically switching to the broadcast alternate bearer for the selected broadcast program being broadcast from the mobile broadcast service provider to the portable mobile communications device.
